(19) United States
(12) Patent Application Publication
(10) Pub. No.: US 2025/0175966 A1
(43) Pub. Date: May 29, 2025

(54) METHOD, DEVICE AND COMPUTER STORAGE MEDIUM OF COMMUNICATION

(71) Applicant: NEC CORPORATION, Tokyo (JP)

(72) Inventors: Gang WANG, Beijing (CN); Peng GUAN, Beijing (CN)

(73) Assignee: NEC CORPORATION, Tokyo (JP)

(21) Appl. No.: 18/841,077

(22) PCT Filed: Feb. 25, 2022
(86) PCT No.: PCT/CN2022/077992

§ 371 Date: Aug. 23, 2024

(51) Int. Cl. H04W 72/044; H04B 7/06; H04L 5/00; H04W 16/28; H04W 24/10; H04W 72/20

(52) U.S. Cl. CPC H04W 72/046; H04B 7/06968; H04L 5/0051; H04W 16/28; H04W 24/10; H04W 72/20

(57) ABSTRACT

Embodiments of the present disclosure relate to methods, devices and computer readable media for communication. In response to transmitting a first reference signal on a resource in a first resource set, a network device transmits, to a repeater device, first control information indicating turn-on of the repeater device, the first resource set being configured for a first measurement of a first link between the repeater device and a terminal device. In response to transmitting a second reference signal on a resource in a second resource set, the network device transmits, to the repeater device, second control information indicating turn-off of the repeater device, the second resource set being configured for a second measurement of a second link between the network device and the terminal device, the first resource set being different from the second resource set. In this way, beam management for a network-controlled repeater device can be achieved.

### TECHNICAL FIELD

Embodiments of the present disclosure generally relate to the field of telecommunication, and in particular, to methods, devices and computer storage media of communication for a network-controlled repeater.

### BACKGROUND

Coverage is a fundamental aspect of cellular network deployments. As known, a radio frequency (RF) repeater may be utilized to simply amplify-and-forward any signal that they receive. While the RF repeater presents a cost effective means of extending network coverage, the RF repeater simply does an amplify-and-forward operation without being able to take into account various factors that could improve performance.

Recently, a network-controlled repeater is introduced by adding side control information for beam management on a basis of the RF repeater. The network-controlled repeater has a capability to receive and process the side control information from a network device. Potential benefits may include mitigation of unnecessary noise amplification, transmissions and receptions with better spatial directivity, and simplified network integration. However, the beam management for the network-controlled repeater is still undefined and needs to be developed.

### SUMMARY

In general, embodiments of the present disclosure provide methods, devices and computer storage media of communication for a network-controlled repeater.

In a first aspect, there is provided a method of communication. The method comprises: in response to transmitting a first reference signal on a resource in a first resource set, transmitting, at a network device and to a repeater device, first control information indicating turn-on of the repeater device, the first resource set being configured for a first measurement of a first link between the repeater device and a terminal device; and in response to transmitting a second reference signal on a resource in a second resource set, transmitting, to the repeater device, second control information indicating turn-off of the repeater device, the second resource set being configured for a second measurement of a second link between the network device and the terminal device, the first resource set being different from the second resource set.

In a second aspect, there is provided a method of communication. The method comprises: in response to receiving, from a network device, first control information indicating turn-on of the repeater device, enabling, at a repeater device, a forwarding of a first reference signal transmission between the network device and a terminal device, the first reference signal transmission being forwarded to the terminal device on a resource in a first resource set, the first resource set being configured for a first measurement of a first link between the repeater device and the terminal device; and in response to receiving, from the network device, second control information indicating turn-off of the repeater device, disabling a forwarding of a second reference signal transmission between the network device and the terminal device, the second reference signal transmission being performed on a resource in a second resource set, the second resource set being configured for a second measurement of a second link between the network device and the terminal device, the first resource set being different from the second resource set.

In a third aspect, there is provided a method of communication. The method comprises: receiving, at a terminal device and from a network device, a configuration regarding a first resource set and a second resource set, the first resource set being configured for a first measurement of a first link between a repeater device and the terminal device, the second resource set being configured for a second measurement of a second link between the network device and the terminal device, the first resource set being different from the second resource set; performing the first and second measurements based on the configuration; and transmitting results of the first and second measurements to the network device.

In a fourth aspect, there is provided a network device. The network device comprises a processor configured to cause the network device to perform the method according to the first aspect of the present disclosure.

In a fifth aspect, there is provided a repeater device. The repeater device comprises a processor configured to cause the repeater device to perform the method according to the second aspect of the present disclosure.

In a sixth aspect, there is provided a terminal device. The terminal device comprises a processor configured to cause the terminal device to perform the method according to the third aspect of the present disclosure.

In a seventh aspect, there is provided a computer readable medium having instructions stored thereon. The instructions, when executed on at least one processor, cause the at least one processor to perform the method according to the first or second or third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example process of communication according to embodiments of the present disclosure;

FIG. 3A illustrates a schematic diagram illustrating an example resource configuration for reference signal (RS) transmission according to embodiments of the present disclosure;

FIG. 3B illustrates a schematic diagram illustrating an example forwarding association with beams of a repeater device and resources for a RS transmission according to embodiments of the present disclosure;

FIG. 3C illustrates a schematic diagram illustrating example scenarios of a RS reception procedure according to embodiments of the present disclosure;

FIG. 4 illustrates an example method of communication implemented at a network device in accordance with some embodiments of the present disclosure;

FIG. 5 illustrates an example method of communication implemented at a repeater device in accordance with some embodiments of the present disclosure;

FIG. 6 illustrates an example method of communication implemented at a terminal device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “repeater” may be interchangeably used with “repeater device”, and the term “beam” may be interchangeably used with “link” or “channel”. In the context of the present application, the term “side control information” may be interchangeably used with “control information”. In the context of the present application, the term “synchronization signal and physical broadcast channel block (SSB) index” may be interchangeably used with “channel state information-reference signal (CSI-RS) index”.

As mentioned above, beam management for a network-controlled repeater needs to be developed. In view of this, embodiments of the present disclosure provide a solution of beam management for the network-controlled repeater. In the solution, a first resource set is configured for a first measurement of a first link between a repeater device and a terminal device, and a second resource set different from the first resource set is configured for a second measurement of a second link between a network device and the terminal device. If a reference signal is transmitted on a resource in a first resource set, the network device transmits, to the repeater device, first control information indicating turn-on of the repeater device. If a reference signal is transmitted on a resource in a second resource set, the network device transmits, to the repeater device, second control information indicating turn-off of the repeater device.

In this way, an on-off state of a repeater device is caused to be associated with RS transmissions on different resource sets configured for different link measurements. Thus, the link measurements can be performed, and corresponding link management can be achieved.

Principles and implementations of the present disclosure will be described in detail below with reference to the figures.

### Example of Communication Network

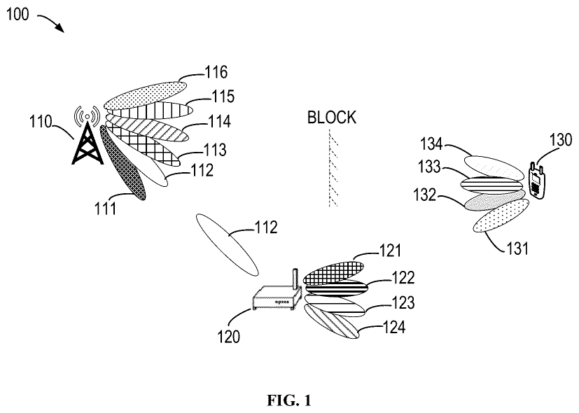

FIG. 1 illustrates a schematic diagram of an example communication network 100 in which embodiments of the present disclosure can be implemented. As shown in FIG. 1, the communication network 100 may comprise a network device 110, a repeater device 120 and a terminal device 130. The network device 110 may serve the terminal device 130.

In some embodiments, the network device 110 may directly communicate with the terminal device 130. In some embodiments, the network device 110 may communicate with the terminal device 130 via the repeater device 120. The repeater device 120 may have a forwarding function (also referred to as a normal operation mode) and a monitoring function (also referred to as a low power consumption mode). In the normal operation mode, the repeater device 120 may forward a signal transmission between the network device 110 and the terminal device 130. That is, the repeater device 120 may receive a signal from the network device 110, then amplify the received signal and forward the amplified signal to the terminal device 130. Or the repeater device 120 may receive a signal from the terminal device 130, then amplify the received signal and forward the amplified signal to the network device 110. In the low power consumption mode, the repeater device 120 may intermittently or periodically monitor a signal from the network device 110.

In some embodiments, the network device 110 may transmit side control information to the repeater device 120. The side control information may comprise at least one of the following: beamforming information, timing information to align transmission or reception boundaries of the repeater device 120, information on uplink (UL)-downlink (DL) time division duplex (TDD) configuration, on-off information for efficient interference management and improved energy efficiency, or power control information for efficient interference management.

As shown in FIG. 1, the network device 110 may support six beams 111, 112, 113, 114, 115 and 116 for communication, the repeater device 120 may support five beams 121, 122, 123, 124, and 125 for communication, and the terminal device 130 may support four beams 131, 132, 133 and 134 for communication. These beams may serve as transmit beams or receive beams in DL or UL transmission. For convenience, assuming that the beams 111, 112, 113, 114, 115 and 116 are transmit beams of the network device 110 in DL transmission, the beams 121, 122, 123 and 124 are transmit beams of the repeater device 120 in DL transmission, the beam 125 is a receive beam of the repeater device 120 in DL transmission, and the beams 131, 132, 133 and 134 are receive beams of the terminal device 130 in DL transmission.

It is to be understood that the number of devices or beams in FIG. 1 is given for the purpose of illustration without suggesting any limitations to the present disclosure. The communication network 100 may involve any suitable number of network devices and/or repeater devices and/or terminal devices and/or beams adapted for implementing implementations of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some scenarios, as the terminal device 130 moves, a block may occur between the network device 110 and the terminal device 130. As shown in FIG. 1, no beam pair may be formed between the network device 110 and the terminal device 130, and a beam pair (for example, the beam 112 and the beam 125) may be formed between the network device 110 and the repeater device 120. In this case, the repeater device 120 may perform a forwarding function between the network device 110 and the terminal device 130. That is, the network device 110 may communicate with the terminal device 130 via the repeater device 120.

In some scenarios, as the terminal device 130 further moves, the terminal device 130 may far away from the block and beam pairs may be formed between the network device 110 and the terminal device 130. Thus, the network device 110 and the terminal device 130 may directly communicate with the terminal device 130. Alternatively, the network device 110 may also communicate with the terminal device 130 via the repeater device 120. In this case, how to perform beam or link management is to be addressed.

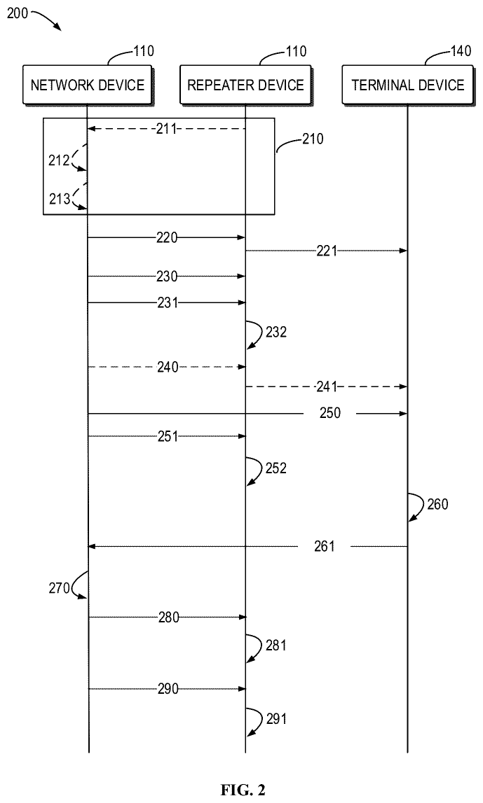

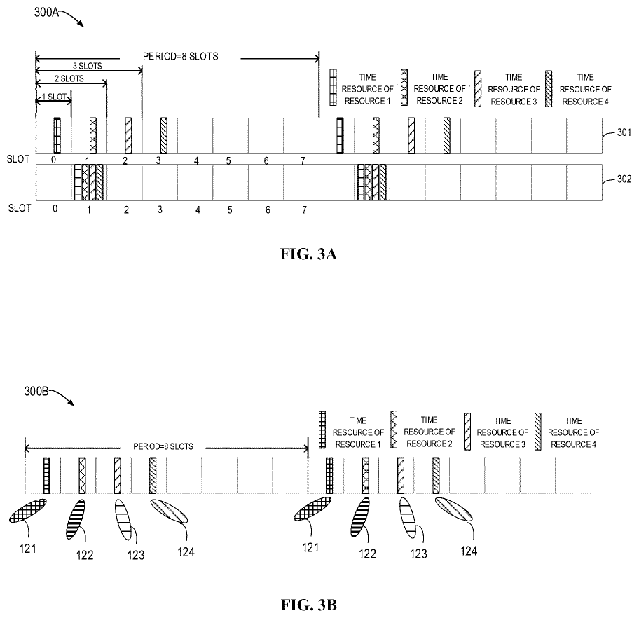

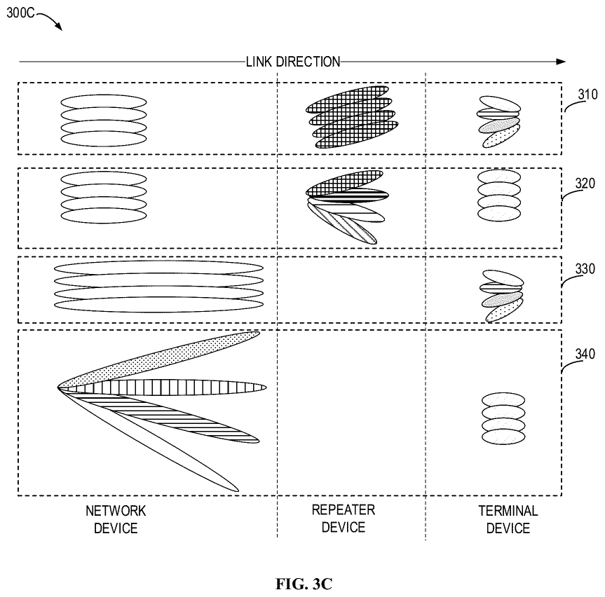

Embodiments of the present disclosure provide a solution for beam or link management. In the solution, an on-off state of a repeater device is associated with RS transmissions on different resource sets configured for different link measurements. In this way, a link measurement and an optimized link determination may be facilitated. For illustration, some example embodiments will be described in connection with FIGS. 2 to 3C.

### Example Implementation of Beam or Link Management

FIG. 2 illustrates a schematic diagram illustrating an example process 200 of communication according to embodiments of the present disclosure. For the purpose of discussion, the process 200 will be described with reference to FIG. 1. The process 200 may involve the network device 110, the repeater device 120 and the terminal device 130 as illustrated in FIG. 1.

As the location of the network device 110 and the repeater device 120 is relatively fixed, the beam pair between the network device 110 and the repeater device 120 is fixed. Thus, a link between the network device 110 and the repeater device 120 may be not considered in link measurement or management. In the present solution, a link (for convenience, also referred to as a first link herein) between the repeater device 120 and the terminal device 130 and a link (for convenience, also referred to as a second link herein) between the network device 110 and the terminal device 130 are considered.

### 1. Configuration of Resource Sets

As shown in FIG. 2, the network device 110 determines 210 a resource set (for convenience, also referred to as a first resource set herein) configured for a measurement (for convenience, also referred to as a first measurement herein) of the first link and another resource set (for convenience, also referred to as a second resource set herein) configured for a measurement (for convenience, also referred to as a second measurement herein) of the second link.

In some embodiments, the first resource set may be different from the second resource set. In some embodiments, the first resource set may have no overlap with the second resource set. In other words, an index of a resource in the first resource set is different from that of any one resource in the second resource set. In this way, an accurate beam or link measurement may be achieved.

With reference to FIG. 2, in some embodiments, the repeater device 120 may transmit 211, to the network device 110, information of a set of transmit beams (for example, the beams 121, 122, 123 and 124) supported by the repeater device 120 in DL transmission. Based on the information of the set of transmit beams, the network device 110 may determine 212 the first resource set.

In some embodiments, the information of the set of transmit beams may comprise at least one of the following: the number of transmit beams in the set of transmit beams, a width of a transmit beam in the set of transmit beams, a gain of a transmit beam in the set of transmit beams, or a speed or capability of a beam switching among the set of transmit beams. It is to be understood that this is merely an example, and any other suitable information may also be feasible.

In some embodiments, the network device 110 may determine the first resource set by causing the number of resources in the first resource set to be equal to the number of transmit beams in the set of transmit beams supported by the repeater device 120 in DL transmission. In this way, a measurement for the set of transmit beams of the repeater device 120 may be facilitated.

In some embodiments, the network device 110 may determine the first resource set by causing a resource in the first resource set to be associated with a transmit beam in the set of transmit beams supported by the repeater device 120 in DL transmission. In other words, each resource in the first resource set is associated with one transmit beam of the repeater device 120 in DL transmission. In this way, an accurate measurement for the set of transmit beams of the repeater device 120 may be facilitated.

In some embodiments, the network device 110 may determine the first resource set by causing resources in the first resource set to have the same periodicity. In some embodiments, the network device 110 may determine the first resource set by causing the resources in the first resource set to have different slot offsets if a granularity of beam switching among the set of transmit beams is slot or slot-level. In some alternative embodiments, the network device 110 may determine the first resource set by causing the resources in the first resource set to have the same slot offset if the granularity of the beam switching among the set of transmit beams is symbol. For illustration, an example will be described in connection with FIG. 3A.

FIG. 3A illustrates a schematic diagram 300A illustrating an example resource configuration for RS transmission according to embodiments of the present disclosure. Assuming that the first resource set may comprise resource 1, resource 2, resource 3 and resource 4. The beam 121 is associated with resource 1, the beam 122 is associated with resource 2, the beam 123 is associated with resource 3, and the beam 124 is associated with resource 4.

As shown by reference sign 301 in FIG. 3A, the granularity of beam switching is slot. The resource 1, resource 2, resource 3 and resource 4 have the same periodicity and different slot offsets. Here, a slot offset refers to an offset of a slot in which a resource is located from slot 0. The period of each of the resource 1, resource 2, resource 3 and resource 4 is 8 slots. The resource 1 has an offset of 0 slot, and is located at slot 0. The resource 2 has an offset of 1 slot, and is located at slot 1. The resource 3 has an offset of 2 slots, and is located at slot 2. The resource 4 has an offset of 3 slots, and is located at slot 3.

As shown by reference sign 302 in FIG. 3A, the granularity of beam switching is symbol. The resource 1, resource 2, resource 3 and resource 4 have the same periodicity and offset. The period of each of the resource 1, resource 2, resource 3 and resource 4 is 8 slots. The offset of each of the resource 1, resource 2, resource 3 and resource 4 is an offset of 1 slot. The resource 1, resource 2, resource 3 and resource 4 are located at different symbols within slot 1. It is to be understood that FIG. 3A is merely an example, and is not intended to limit the present disclosure.

In some embodiments, the network device 110 may determine the first resource set by causing quasi co-location (QCL) information of the resources in the first resource set to be associated with a SSB index of an transmit beam (for convenience, also referred to as a first transmit beam herein) supported by the network device 110 in DL transmission. The first transmit beam and a receive beam supported by the repeater device 120 in DL transmission may form a fix beam pair between the network device 110 and the repeater device 120. For example, the first transmit beam is the beam 112, and the receive beam is the beam 125. In this case, the QCL information of the resources in the first resource set is the same.

In some alternative embodiments, the network device 110 may determine the first resource set by causing QCL information of the resources in the first resource set to be associated with a set of SSB indexes other than the SSB index of the first transmit beam. In some embodiments, QCL information of each of the resources in the first resource set is associated with a corresponding one of the set of SSB indexes. For example, each SSB index in the set of SSB indexes may be larger than 64. Higher or lower 6 bits in this SSB index may be the same as that for the SSB index of the first transmit beam and remaining bit or bits may be associated with a resource index or a beam index of the first transmit beam. It is to be understood that this is merely an example, and any other suitable ways are also feasible. In this case, the QCL information of the resources in the first resource set is different.

In some embodiments, the network device 110 may determine the second resource set by causing the number of resources in the second resource set to be the number of transmit beams supported by the network device 110 in DL transmission. In some alternative embodiments, the network device 110 may determine the second resource set by causing the number of resources in the second resource set to be the number of transmit beams supported by the network device 110 minus one. In this case, a link built on the first transmit beam (e.g., the beam 112) is measured based on the first resource set.

Upon determination of the first and second resource sets, the network device 110 may generate 213 a configuration regarding the first and second resource sets. For example, two CSI resource settings (CSI-ResourceConfig) with two periodic non-zero-power (NZP) CSI-RS resource sets may be generated, and each NZP CSI-RS resource set is associated with a corresponding one of the two CSI resource settings.

In some embodiments, the configuration may comprise a first period for the first resource set and a second period for the second resource set. In some embodiments, the first period may be shorter than the second period. This may make sure that a channel is measured in time, and resource overhead for channel measurement is minimized. It is to be understood that this is merely an example, and any other suitable ways are also feasible. For example, the second period may be shorter than or equal to the first period.

Then the network device 110 may transmit the configuration to the terminal device 130. In some embodiments where the network device 110 communicates with the terminal device 130 via the repeater device 120, the network device 110 may transmit 220 the configuration to the repeater device 120 and the repeater device 120 may forward 221 the configuration to the terminal device 130. In some alternative embodiments where the network device 110 directly communicates with the terminal device 130, the network device 110 may transmit the configuration to the terminal device 130 directly.

### 2. On-Off Control of Repeater Device

Still with reference to FIG. 2, the network device 110 may transmit 230 a reference signal (for convenience, also referred to as a first reference signal herein) on a resource in the first resource set. In response to the transmission of the first reference signal, the network device 110 transmits 231, to the repeater device 120, control information (for convenience, also referred to as first control information herein) indicating turn-on of the repeater device 120.

In some embodiments, the first control information may comprise starting time and ending time for the turn-on of the repeater device 120. For example, the starting time and the ending time may be absolute values. As another example, the starting time and the ending time may be relative values. In some embodiments, the first control information may comprise starting time and a duration for the turn-on of the repeater device 120. It is to be noted that the first control information may also adopt any other suitable forms. For example, in some embodiments, the first control information may comprise a bit indicating the turn-on of the repeater device 120. In some embodiments, the first control information may comprise a bit indicating maintaining or changing of an on-off state of the repeater device 120.

Based on the first control information, the repeater device 120 turns on 232 at least its forwarding function (including amplifying function). In some embodiments, the repeater device 120 may forward the first reference signal to the terminal device 130. For example, if the first control information comprises starting time and ending time for the turn-on of the repeater device 120, the repeater device 120 may turn on its transceiver at the starting time and turn off its transceiver at the ending time. As another example, if the first control information comprises starting time and a duration for the turn-on of the repeater device 120, the repeater device 120 may start a timer while turning on its transceiver at the starting time and turn off its transceiver when the timer expiries.

In some embodiments where the first reference signal is transmitted on the resource in the first resource set, the network device 110 may further transmit 240, to the repeater device 120, control information (for convenience, also referred to as third control information herein) regarding beam switching for the repeater device 120. In some embodiments, the third control information may comprise at least one of the following: starting time for the beam switching, a duration for the beam switching, or ending time for the beam switching. Of course, any other suitable forms are also feasible.

Based on the third control information, the repeater device 120 may forward 241 the first reference signal from the network device 110 to the terminal device 130 with different directions. FIG. 3B illustrates a schematic diagram 300B illustrating an example forwarding association with beams of the repeater device 120 and resources for a RS transmission according to embodiments of the present disclosure. As shown in FIG. 3B, a RS on resource 1 is forwarded via the beam 121, a RS on resource 2 is forwarded via the beam 122, a RS on resource 3 is forwarded via the beam 123, and a RS on resource 4 is forwarded via the beam 124. It can be seen that RSs on different resources are forwarded with different beams, or different DL spatial domain transmission filters. In this way, beam management may be carried out, and a measurement for the first link may be facilitated.

In some embodiments, the network device 110 may transmit 250 a reference signal (for convenience, also referred to as a second reference signal herein) on a resource in the second resource set. In response to the transmission of the second reference signal, the network device 110 transmits 251, to the repeater device 120, control information (for convenience, also referred to as second control information herein) indicating turn-off of the repeater device 120.

In some embodiments, the second control information may comprise starting time and ending time for the turn-off of the repeater device 120. For example, the starting time and the ending time may be absolute values. As another example, the starting time and the ending time may be relative values. In some embodiments, the second control information may comprise starting time and a duration for the turn-off of the repeater device 120. It is to be noted that the second control information may also adopt any other suitable forms. For example, in some embodiments, the second control information may comprise a bit indicating the turn-off of the repeater device 120. In some embodiments, the second control information may comprise a bit indicating maintaining or changing of an on-off state of the repeater device 120.

Based on the second control information, the repeater device 120 turns off 252 at least its forwarding function. For example, if the second control information comprises starting time and ending time for the turn-off of the repeater device 120, the repeater device 120 may turn off its transceiver at the starting time and turn on its transceiver at the ending time. As another example, if the second control information comprises starting time and a duration for the turn-off of the repeater device 120, the repeater device 120 may start a timer while turning off its transceiver at the starting time and turn on its transceiver when the timer expiries.

The turn-off of the repeater device 120 may ensure that no interference is introduced by the repeater device 120 for channel measurement of the second link between the network device 110 and the terminal device 130.

In some embodiments, the repeater device 120 may turn off its forwarding function and maintain its monitoring function. In this way, it is ensured that the repeater device 120 may be turn on timely when the network device 110 requires the turn-on of the repeater device 120. In some alternative embodiments, the repeater device 120 may turn off both the forwarding function and the monitoring function. In the case that the repeater device 120 turns off, the network device 110 may transmit the first RS to the terminal device 130 directly. In this way, a measurement for the second link may be facilitated.

### 3. Beam or Link Measurement

Still with reference to FIG. 2, upon reception of the first and second RSs, the terminal device 130 performs 260, a measurement (for convenience, also referred to as a first measurement) on the first RS and a measurement (for convenience, also referred to as a second measurement) on the second RS. For example, the terminal device 130 may receive the configuration regarding the first and second resource set from the network device 110. Based on the configuration, the terminal device 130 may receive the first and second RSs and measure the first and second RSs.

In some embodiments, the configuration may comprise a parameter (for example, repetition) indicating whether a RS is transmitted with the same downlink spatial domain transmission filter. In these embodiments, the terminal device 130 may receive the RS in a link based on the parameter regardless of the presence or absence of the repeater device 120 in the link. An explanation will be given in connection with FIG. 3C. FIG. 3C illustrates a schematic diagram 300C illustrating example scenarios of a RS reception procedure according to embodiments of the present disclosure.

In scenario 310 in FIG. 3C, the repeater device 120 turns on, and the parameter indicates that a RS is transmitted with the same downlink spatial domain transmission filter (i.e., repetition is set to be “on”). Further, the network device 110 transmits a RS in one direction with multiple times. Accordingly, the repeater device 120 forwards the RS in one direction with multiple times. In this scenario, the terminal device 130 may receive the RS with different directions. A direction is associated with one beam.

In scenario 320 in FIG. 3C, the repeater device 120 turns on, and the parameter indicates that a RS is not transmitted with the same downlink spatial domain transmission filter (i.e., repetition is set to be “off”). Further, the network device 110 transmits a RS in one direction with multiple times. The repeater device 120 forwards the RS in multiple different directions. In this scenario, the terminal device 130 may receive the RS with one direction.

In scenario 330 in FIG. 3C, the repeater device 120 turns off, and the parameter indicates that a RS is transmitted with the same downlink spatial domain transmission filter (i.e., repetition is set to be “on”). Further, the network device 110 transmits a RS in one direction with multiple times. In this scenario, the terminal device 130 may receive the RS with different directions.

In scenario 340 in FIG. 3C, the repeater device 120 turns off, and the parameter indicates that a RS is not transmitted with the same downlink spatial domain transmission filter (i.e., repetition is set to be “off”). Further, the network device 110 transmits a RS in multiple directions. In this scenario, the terminal device 130 may receive the RS with one direction. It can be seen that the terminal device 130 may operate according to the parameter repetition whether the repeater device 120 is introduced in the link or not.

In some embodiments, the terminal device 130 may measure reference signal receiving power (RSRP) of the first and second RSs. In some embodiments, the terminal device 130 may measure reference signal receiving quality (RSRQ) of the first and second RSs. It is to be understood that these are merely examples, and any other suitable parameters are also feasible. With the first measurement, the terminal device 130 may obtain RSRP associated with each resource in the first resource set corresponding to the beams 121 to 124. With the second measurement, the terminal device 130 may obtain RSRP associated with each resource in the second resource set corresponding to the beams 111 to 116.

The terminal device 130 transmits results of the first and second measurements to the network device 110. For example, the terminal device 130 may transmits RSRP with CSI-RS resource indicator (CRI) of each resource associated with unique resource index. In some embodiments where the network device 110 directly communicates with the terminal device 130, the terminal device 130 may transmit 261 the results of the first and second measurements to the network device 110 directly. In some embodiments where the network device 110 communicates with the terminal device 130 via the repeater device 120, the terminal device 130 may transmit the results of the first and second measurements to the repeater device 120 and the repeater device 120 may forward the results of the first and second measurements to the network device 110.

It is to be noted that the present disclosure does not limit the order of the first and second measurements, and also does not limit the order of feedback of the results of the first and second measurements.

In some embodiments, the terminal device 130 is not required to perform the first and second measurements for more than N resources, where N is larger than 64. For example, assuming that the maximum number of transmit beams of a repeater device is 8, UE may satisfy the following:

If UE is configured with a CSI-ReportConfig with the higher layer parameter reportQuantity set to ‘cri-RSRP’ or ‘ssb-Index-RSRP’,
if the UE is configured with the higher layer parameter groupBasedBeamReporting set to ‘disabled’, the UE is not required to update measurements for more than 72 CSI-RS and/or SSB resources, and the UE shall report in a single report nrofReportedRS (higher layer configured) different CRI or SSBRI for each report setting.
if the UE is configured with the higher layer parameter groupBasedBeamReporting set to ‘enabled’, the UE is not required to update measurements for more than 72 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

### 4. Beam or Link Management

Still with reference to FIG. 2, upon reception of the results of the first and second measurements, the network device 110 determines 270, based on the results, whether the first link or the second link is to be used for communication between the network device 110 and the terminal device 130.

In some embodiments, the network device 110 may determine a selected resource corresponding to a result in the results, the result indicating a link quality higher than a threshold quality. For example, the result may indicate the best link quality, e.g., the highest RSRP or RSRQ. With a CRI corresponding to the highest RSRP or RSRQ, the selected resource may be determined.

If the selected resource belongs to the first resource set, the network device 110 may determine that the first link is to be used. That is, the best transmit beam is a transmit beam of the repeater device 120 in DL transmission. In this case, the network device 110 may communicate with the terminal device 130 by a connected link (for example, the beam pair of the beams 112 and 125) between the network device 110 and the repeater device 120 and the first link between the repeater device 120 and the terminal device 130.

With reference to FIG. 2, if the first link is to be used, the network device 110 transmits 281, to the repeater device 120, control information (for convenience, also referred to as fourth control information herein) indicating turn-on of the repeater device 120. Based on the fourth control information, the repeater device 120 turns on 282 at least its forwarding function.

In some embodiments, the fourth control information may comprise a bit indicating the turn-on of the repeater device 120. In some embodiments, the fourth control information may comprise a bit indicating maintaining or changing of an on-off state of the repeater device 120. It is to be noted that the fourth control information may also adopt any other suitable forms. For example, in some embodiments, the fourth control information may comprise starting time and ending time for the turn-on of the repeater device 120. For example, the starting time and the ending time may be absolute values. As another example, the starting time and the ending time may be relative values. In some embodiments, the fourth control information may comprise starting time and a duration for the turn-on of the repeater device 120.

If the selected resource belongs to the second resource set, the network device 110 may determine that the second link is to be used. That is, the best transmit beam is a transmit beam of the network device 110 in DL transmission. In this case, the network device 110 may directly communicate with the terminal device 130 by the second link between the network device 110 and the terminal device 130.

With reference to FIG. 2, if the second link is to be used, the network device 110 transmits 290, to the repeater device 120, control information (for convenience, also referred to as fifth control information herein) indicating turn-off of the repeater device 120. Based on the fifth control information, the repeater device 120 turns off 291 at least its forwarding function. The turn-off of the repeater device 120 may ensure that no interference is introduced by the repeater device 120.

In some embodiments, the repeater device 120 may turn off its forwarding function and maintain its monitoring function. In this way, it is ensured that the repeater device 120 may be turn on timely when the network device 110 requires the turn-on of the repeater device 120. In some alternative embodiments, the repeater device 120 may turn off both the forwarding function and the monitoring function.

In some embodiments, the fifth control information may comprise a bit indicating the turn-off of the repeater device 120. In some embodiments, the fifth control information may comprise a bit indicating maintaining or changing of an on-off state of the repeater device 120. It is to be noted that the fifth control information may also adopt any other suitable forms. For example, in some embodiments, the fifth control information may comprise starting time and ending time for the turn-off of the repeater device 120. For example, the starting time and the ending time may be absolute values. As another example, the starting time and the ending time may be relative values. In some embodiments, the fifth control information may comprise starting time and a duration for the turn-off of the repeater device 120.

With the process 200, beam management for a network-controlled repeater is achieved. It to be noted that the process 200 may comprise more additional steps or omit some steps shown, and the present disclosure does not limit the order of the steps.

### Example Implementation of Methods

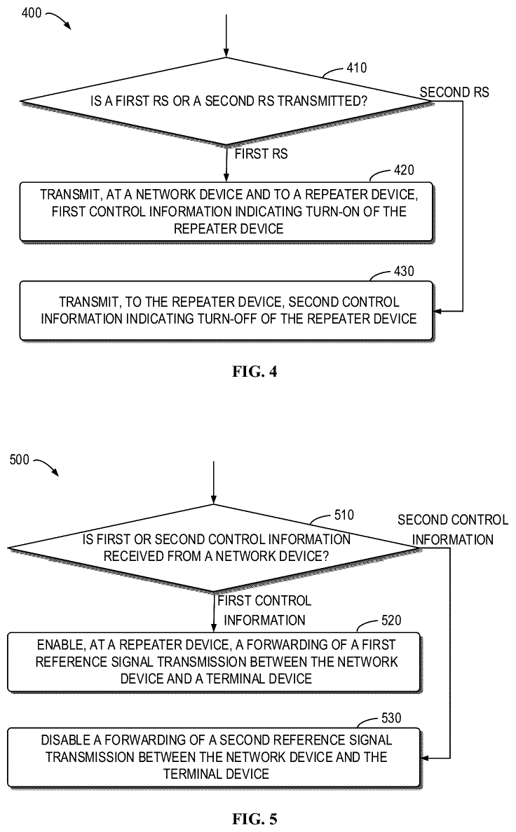

Accordingly, embodiments of the present disclosure provide methods of communication implemented at a network device, a repeater device and a terminal device. These methods will be described below with reference to FIGS. 4 to 6.

FIG. 4 illustrates an example method 400 of communication implemented at a network device in accordance with some embodiments of the present disclosure. For example, the method 400 may be performed at the network device 110 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the network device 110 determines whether a first reference signal is transmitted on a resource in a first resource set or a second reference signal is transmitted on a resource in a second resource set. The first resource set is configured for a first measurement of a first link between the repeater device 120 and the terminal device 130. The second resource set is configured for a second measurement of a second link between the network device 110 and the terminal device 130. The first resource set is different from the second resource set.

If the first reference signal is transmitted on the resource in the first resource set, the method 400 proceeds to block 420. At block 420, the network device 110 transmits, to the repeater device 120, first control information indicating turn-on of the repeater device 120.

If the second reference signal is transmitted on the resource in the second resource set, the method 400 proceeds to block 430. At block 430, the network device 110 transmits, to the repeater device 120, second control information indicating turn-off of the repeater device 120.

In some embodiments, if the first reference signal is transmitted on the resource in the first resource set, the network device 110 may transmit, to the repeater device 120, third control information regarding beam switching for the repeater device 120.

In some embodiments, the network device 110 may generate a configuration regarding the first resource set and the second resource set, and transmit the configuration to the terminal device 130. In some embodiments, the configuration may comprise a first period for the first resource set and a second period for the second resource set, the first period being shorter than the second period.

In some embodiments, the network device 110 may receive, from the repeater device 120, information of a set of transmit beams supported by the repeater device 120 in DL transmission and determine the first resource set based on the information of the set of transmit beams. In some embodiments, the information of the set of transmit beams may comprise at least one of the following: the number of transmit beams in the set of transmit beams, a width of a transmit beam in the set of transmit beams, a gain of a transmit beam in the set of transmit beams, or a speed or capability of a beam switching among the set of transmit beams.

In some embodiments, the network device 110 may determine the first resource set by at least one of the following: causing the number of resources in the first resource set to be equal to the number of transmit beams in the set of transmit beams; causing a resource in the first resource set to be associated with a transmit beam in the set of transmit beams; causing resources in the first resource set to have the same periodicity; causing the resources in the first resource set to have different offsets if a granularity of beam switching among the set of transmit beams is slot; causing the resources in the first resource set to have the same offset if the granularity of the beam switching among the set of transmit beams is symbol; causing quasi co-location information of the resources in the first resource set to be associated with a synchronization signal and physical broadcast channel block, SSB, index of a first transmit beam supported by the network device 110 in DL transmission, the first transmit beam and a receive beam supported by the repeater device 120 in downlink transmission forming a fix beam pair between the network device and the repeater device; or causing quasi co-location information of the resources in the first resource set to be associated with a set of SSB indexes other than the SSB index of the first transmit beam.

In some embodiments, the network device 110 may determine the second resource set by causing the number of resources in the second resource set to be the number of transmit beams supported by the network device 110 in DL transmission or the number of transmit beams supported by the network device 110 minus one.

In some embodiments, the network device 110 may receive results of the first and second measurements from the terminal device 130, and determine, based on the results, whether the first link or the second link is to be used for communication between the network device 110 and the terminal device 130.

In some embodiments, the network device 110 may determine whether the first link or the second link is to be used by determining a selected resource corresponding to a result in the results, the result indicating a link quality higher than a threshold quality; in accordance with a determination that the selected resource belongs to the first resource set, determining that the first link is to be used for the communication between the network device 110 and the terminal device 130; and in accordance with a determination that the selected resource belongs to the second resource set, determining that the second link is to be used for the communication between the network device 110 and the terminal device 130.

In some embodiments, if the first link is to be used, the network device 110 may transmit, to the repeater device 120, fourth control information indicating turn-on of the repeater device 120. If the second link is to be used, the network device 110 may transmit, to the repeater device 120, fifth control information indicating turn-off of the repeater device 120.

In some embodiments, the first control information or the fourth control information may comprise at least one of the following: starting time and ending time for the turn-on of the repeater device 120; starting time and a duration for the turn-on of the repeater device 120; a bit indicating the turn-on of the repeater device 120; or a bit indicating maintaining or changing of an on-off state of the repeater device 120.

In some embodiments, the second control information or the fifth control information may comprise at least one of the following: starting time and ending time for the turn-off of the repeater device; starting time and a duration for the turn-off of the repeater device; a bit indicating the turn-off of the repeater device; or a bit indicating maintaining or changing of an on-off state of the repeater device.

With the method 400, turn-on or turn-off of a repeater device can be controlled in associated with different resource sets for different link measurements. Thereby, beam management for a repeater device can be achieved.

FIG. 5 illustrates an example method 500 of communication implemented at a repeater device in accordance with some embodiments of the present disclosure. For example, the method 500 may be performed at the repeater device 120 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the repeater device 120 determines whether first or second control information is received from the network device 110. The first control information indicates turn-on of the repeater device 120. The second control information indicates turn-off of the repeater device 120.

If the first control information is received, the method 500 proceeds to block 520. At block 520, the repeater device 120 enables a forwarding of a first reference signal transmission between the network device 110 and the terminal device 130. The first reference signal transmission is forwarded to the terminal device 130 on a resource in a first resource set, and the first resource set is configured for a first measurement of a first link between the repeater device 120 and the terminal device 130.

If the second control information is received, the method 500 proceeds to block 530. At block 530, the repeater device 120 disables a forwarding of a second reference signal transmission between the network device 110 and the terminal device 130. The second reference signal transmission is performed on a resource in a second resource set, and the second resource set is configured for a second measurement of a second link between the network device 110 and the terminal device 130. The first resource set is different from the second resource set.

In some embodiments, the repeater device 120 may receive, from the network device 110, third control information regarding beam switching for the repeater device 120, and forward, based on the third control information, the first reference signal transmission from the network device 110 to the terminal device 130 with different directions.

In some embodiments, the repeater device 120 may transmit, to the network device 110, information of a set of transmit beams supported by the repeater device 120 in downlink transmission. In some embodiments, the information of the set of transmit beams may comprise at least one of the following: the number of transmit beams in the set of transmit beams, a width of a transmit beam in the set of transmit beams, a gain of a transmit beam in the set of transmit beams, or a speed or capability of a beam switching among the set of transmit beams.

In some embodiments, in response to receiving, from the network device 110, fourth control information indicating turn-on of the repeater device 120, the repeater device 120 may enable a forwarding of a first signal transmission between the network device 110 and the terminal device 130. The first signal transmission is forwarded on the first link. In response to receiving, from the network device 110, fifth control information indicating turn-off of the repeater device 120, the repeater device 120 may disable a forwarding of a second signal transmission between the network device 110 and the terminal device 130. The second signal transmission is performed on the second link.

In some embodiments, the first control information or the fourth control information may comprise at least one of the following: starting time and ending time for the turn-on of the repeater device 120; starting time and a duration for the turn-on of the repeater device; a bit indicating the turn-on of the repeater device 120; or a bit indicating maintaining or changing of an on-off state of the repeater device 120;

In some embodiments, the second control information or the fifth control information may comprise at least one of the following: starting time and ending time for the turn-off of the repeater device 120; starting time and a duration for the turn-off of the repeater device 120; a bit indicating the turn-off of the repeater device 120; or a bit indicating maintaining or changing of an on-off state of the repeater device 120.

With the method 500, a repeater device can turn on or turn off based on control information from a network device for beam measurement and management.

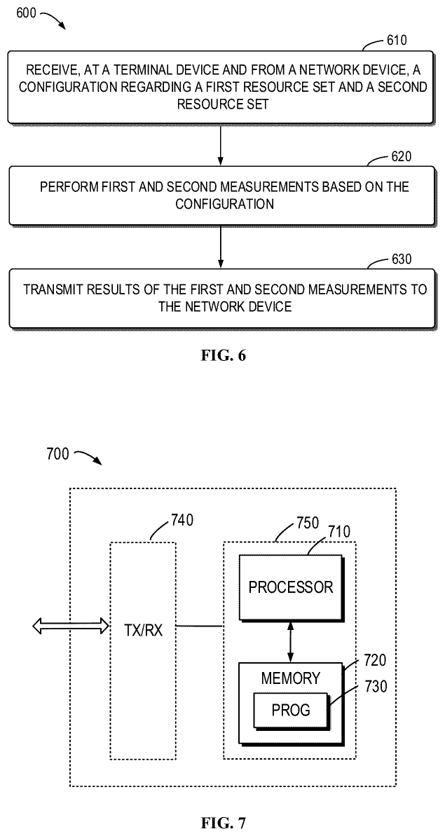

FIG. 6 illustrates an example method 600 of communication implemented at a terminal device in accordance with some embodiments of the present disclosure. For example, the method 600 may be performed at the terminal device 130 as shown in FIG. 1. For the purpose of discussion, in the following, the method 600 will be described with reference to the terminal device 130 in FIG. 1. It is to be understood that the method 600 may include additional blocks not shown and/or may omit some blocks as shown, and the scope of the present disclosure is not limited in this regard.

At block 610, the terminal device 130 receives, from the network device 110, a configuration regarding a first resource set and a second resource set. The first resource set is configured for a first measurement of a first link between the repeater device 120 and the terminal device 130. The second resource set is configured for a second measurement of a second link between the network device 110 and the terminal device 130. The first resource set is different from the second resource set. In some embodiments, the configuration may comprise a first period for the first resource set and a second period for the second resource set, the first period being shorter than the second period.

In some embodiments, the number of resources in the first resource set may be equal to the number of transmit beams in a set of transmit beams supported by the repeater device in downlink transmission. In some embodiments, a resource in the first resource set may be associated with a transmit beam in the set of transmit beams. In some embodiments, resources in the first resource set may have the same periodicity. In some embodiments, the resources in the first resource set may have different offsets. In some embodiments, the resources in the first resource set may have the same offset. In some embodiments, quasi co-location information of the resources in the first resource set may be associated with a SSB index of a first transmit beam supported by the network device 110. The first transmit beam and a receive beam supported by the repeater device in downlink transmission form a fix beam pair between the network device 110 and the repeater device 120. In some embodiments, quasi co-location information of the resources in the first resource set is associated with a set of SSB indexes other than the SSB index of the first transmit beam.

In some embodiments, the number of resources in the second resource set may be equal to the number of transmit beams supported by the network device 110 in downlink transmission or the number of transmit beams supported by the network device 110 minus one.

In some embodiments, the configuration may comprise a parameter indicating whether a reference signal is transmitted with the same downlink spatial domain transmission filter. In these embodiments, the terminal device 130 may receive the reference signal in a link based on the parameter regardless of the presence or absence of the repeater device 129 in the link.

At block 620, the terminal device 130 performs the first and second measurements based on the configuration. In some embodiments, the terminal device 13 is not required to perform the first and second measurements for more than a predetermined number of resources. In some embodiments, the predetermined number may be larger than 64.

At block 630, the terminal device 130 transmits results of the first and second measurements to the network device 110.

With the method 600, beam measurement for a network-controlled repeater device can be achieved, and beam management can be facilitated accordingly.

### Example Implementation of Device and Apparatus

FIG. 7 is a simplified block diagram of a device 700 that is suitable for implementing embodiments of the present disclosure. The device 700 can be considered as a further example implementation of the network device 110 or the repeater device 120 or the terminal device 130 as shown in FIG. 1. Accordingly, the device 700 can be implemented at or as at least a part of the network device 110 or the repeater device 120 or the terminal device 130.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a network device comprises a circuitry configured to: in response to transmitting a first reference signal on a resource in a first resource set, transmit, to a repeater device, first control information indicating turn-on of the repeater device, the first resource set being configured for a first measurement of a first link between the repeater device and a terminal device; and in response to transmitting a second reference signal on a resource in a second resource set, transmit, to the repeater device, second control information indicating turn-off of the repeater device, the second resource set being configured for a second measurement of a second link between the network device and the terminal device, the first resource set being different from the second resource set.

In some embodiments, the circuitry may be further configured to: in response to transmitting the first reference signal on the resource in the first resource set, transmit, to the repeater device, third control information regarding beam switching for the repeater device.

In some embodiments, the circuitry may be further configured to: generate a configuration regarding the first resource set and the second resource set; and transmit the configuration to the terminal device.

In some embodiments, the configuration comprises a first period for the first resource set and a second period for the second resource set, the first period being shorter than the second period.

In some embodiments, the circuitry may be configured to generate the configuration by: receiving, from the repeater device, information of a set of transmit beams supported by the repeater device in downlink transmission; and determining the first resource set based on the information of the set of transmit beams. In some embodiments, the information of the set of transmit beams may comprise at least one of the following: the number of transmit beams in the set of transmit beams, a width of a transmit beam in the set of transmit beams, a gain of a transmit beam in the set of transmit beams, or a speed or capability of a beam switching among the set of transmit beams.

In some embodiments, the circuitry may be configured to determine the first resource set by at least one of the following: causing the number of resources in the first resource set to be equal to the number of transmit beams in the set of transmit beams; causing a resource in the first resource set to be associated with a transmit beam in the set of transmit beams; causing resources in the first resource set to have the same periodicity; causing the resources in the first resource set to have different offsets if a granularity of beam switching among the set of transmit beams is slot; causing the resources in the first resource set to have the same offset if the granularity of the beam switching among the set of transmit beams is symbol; causing quasi co-location information of the resources in the first resource set to be associated with a synchronization signal and physical broadcast channel block, SSB, index of a first transmit beam supported by the network device in downlink transmission, the first transmit beam and a receive beam supported by the repeater device in downlink transmission forming a fix beam pair between the network device and the repeater device; or causing quasi co-location information of the resources in the first resource set to be associated with a set of SSB indexes other than the SSB index of the first transmit beam.

In some embodiments, the circuitry may be configured to generate the configuration by determining the second resource set by causing the number of resources in the second resource set to be the number of transmit beams supported by the network device in downlink transmission or the number of transmit beams supported by the network device minus one.

In some embodiments, the circuitry may be further configured to: receive results of the first and second measurements from the terminal device; and determine, based on the results, whether the first link or the second link is to be used for communication between the network device and the terminal device.

In some embodiments, the circuitry may be configured to determine whether the first link or the second link is to be used by: determining a selected resource corresponding to a result in the results, the result indicating a link quality higher than a threshold quality; in accordance with a determination that the selected resource belongs to the first resource set, determining that the first link is to be used for the communication between the network device and the terminal device; and in accordance with a determination that the selected resource belongs to the second resource set, determining that the second link is to be used for the communication between the network device and the terminal device.

In some embodiments, the circuitry may be further configured to: in accordance with a determination that the first link is to be used, transmit, to the repeater device, fourth control information indicating turn-on of the repeater device; and in accordance with a determination that the second link is to be used, transmit, to the repeater device, fifth control information indicating turn-off of the repeater device.

In some embodiments, the first control information or the fourth control information may comprise at least one of the following: starting time and ending time for the turn-on of the repeater device; starting time and a duration for the turn-on of the repeater device; a bit indicating the turn-on of the repeater device; or a bit indicating maintaining or changing of an on-off state of the repeater device.

In some embodiments, the second control information or the fifth control information may comprise at least one of the following: starting time and ending time for the turn-off of the repeater device; starting time and a duration for the turn-off of the repeater device; a bit indicating the turn-off of the repeater device; or a bit indicating maintaining or changing of an on-off state of the repeater device.

In some embodiments, a repeater device comprise a circuitry configured to: in response to receiving, from a network device, first control information indicating turn-on of the repeater device, enable a forwarding of a first reference signal transmission between the network device and a terminal device, the first reference signal transmission being forwarded to the terminal device on a resource in a first resource set, the first resource set being configured for a first measurement of a first link between the repeater device and the terminal device; and in response to receiving, from the network device, second control information indicating turn-off of the repeater device, disable a forwarding of a second reference signal transmission between the network device and the terminal device, the second reference signal transmission being performed on a resource in a second resource set, the second resource set being configured for a second measurement of a second link between the network device and the terminal device, the first resource set being different from the second resource set.

In some embodiments, the circuitry may be further configured to: receive, from the network device, third control information regarding beam switching for the repeater device; and forward, based on the third control information, the first reference signal transmission from the network device to the terminal device with different directions.

In some embodiments, the circuitry may be further configured to: transmit, to the network device, information of a set of transmit beams supported by the repeater device in downlink transmission. In some embodiments, the information of the set of transmit beams may comprise at least one of the following: the number of transmit beams in the set of transmit beams, a width of a transmit beam in the set of transmit beams, a gain of a transmit beam in the set of transmit beams, or a speed or capability of a beam switching among the set of transmit beams.

In some embodiments, the circuitry may be further configured to: in response to receiving, from the network device, fourth control information indicating turn-on of the repeater device, enable a forwarding of a first signal transmission between the network device and the terminal device, the first signal transmission being forwarded on the first link; or in response to receiving, from the network device, fifth control information indicating turn-off of the repeater device, disable a forwarding of a second signal transmission between the network device and the terminal device, the second signal transmission being performed on the second link.

In some embodiments, the first control information or the fourth control information may comprise at least one of the following: starting time and ending time for the turn-on of the repeater device; starting time and a duration for the turn-on of the repeater device; a bit indicating the turn-on of the repeater device; or a bit indicating maintaining or changing of an on-off state of the repeater device;

In some embodiments, the second control information or the fifth control information may comprise at least one of the following: starting time and ending time for the turn-off of the repeater device; starting time and a duration for the turn-off of the repeater device; a bit indicating the turn-off of the repeater device; or a bit indicating maintaining or changing of an on-off state of the repeater device.

In some embodiments, a terminal device comprises a circuitry configured to: receive, from a network device, a configuration regarding a first resource set and a second resource set, the first resource set being configured for a first measurement of a first link between a repeater device and the terminal device, the second resource set being configured for a second measurement of a second link between the network device and the terminal device, the first resource set being different from the second resource set; perform the first and second measurements based on the configuration; and transmit results of the first and second measurements to the network device.

In some embodiments, the terminal device is unrequired to perform the first and second measurements for more than a predetermined number of resources, the predetermined number being larger than 64.

In some embodiments, the configuration comprises a first period for the first resource set and a second period for the second resource set, the first period being shorter than the second period.

In some embodiments, the number of resources in the first resource set is equal to the number of transmit beams in a set of transmit beams supported by the repeater device in downlink transmission. In some embodiments, a resource in the first resource set is associated with a transmit beam in the set of transmit beams. In some embodiments, resources in the first resource set have the same periodicity. In some embodiments, the resources in the first resource set have different offsets. In some embodiments, the resources in the first resource set to have the same offset. In some embodiments, quasi co-location information of the resources in the first resource set is associated with a SSB index of a first transmit beam supported by the network device, the first transmit beam and a receive beam supported by the repeater device in downlink transmission forming a fix beam pair between the network device and the repeater device. In some embodiments, quasi co-location information of the resources in the first resource set is associated with a set of SSB indexes other than the SSB index of the first transmit beam.

In some embodiments, the number of resources in the second resource set is equal to the number of transmit beams supported by the network device in downlink transmission or the number of transmit beams supported by the network device minus one.

In some embodiments, the configuration comprises a parameter indicating whether a reference signal is transmitted with the same downlink spatial domain transmission filter. In these embodiments, the circuitry may be further configured to receive the reference signal in a link based on the parameter regardless of the presence or absence of the repeater device in the link.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
in response to transmitting a first reference signal on a resource in a first resource set, transmitting, at a network device and to a repeater device, first control information indicating turn-on of the repeater device, the first resource set being configured for a first measurement of a first link between the repeater device and a terminal device; and
in response to transmitting a second reference signal on a resource in a second resource set, transmitting, to the repeater device, second control information indicating turn-off of the repeater device, the second resource set being configured for a second measurement of a second link between the network device and the terminal device, the first resource set being different from the second resource set.

2. The method of claim 1, further comprising:
in response to transmitting the first reference signal on the resource in the first resource set, transmitting, to the repeater device, third control information regarding beam switching for the repeater device.

3. The method of claim 1, further comprising:
generating a configuration regarding the first resource set and the second resource set; and
transmitting the configuration to the terminal device.

4. The method of claim 3, wherein the configuration comprises a first period for the first resource set and a second period for the second resource set, the first period being shorter than the second period.

5. The method of claim 3, wherein generating the configuration comprises:
receiving, from the repeater device, information of a set of transmit beams supported by the repeater device in downlink transmission; and
determining the first resource set based on the information of the set of transmit beams.

6. The method of claim 5, wherein the information of the set of transmit beams comprises at least one of the following:
the number of transmit beams in the set of transmit beams,
a width of a transmit beam in the set of transmit beams,
a gain of a transmit beam in the set of transmit beams, or
a speed or capability of a beam switching among the set of transmit beams.

7. The method of claim 5, wherein determining the first resource set comprises at least one of the following:
causing the number of resources in the first resource set to be equal to the number of transmit beams in the set of transmit beams;
causing a resource in the first resource set to be associated with a transmit beam in the set of transmit beams;
causing resources in the first resource set to have the same periodicity;
causing the resources in the first resource set to have different offsets if a granularity of beam switching among the set of transmit beams is slot;
causing the resources in the first resource set to have the same offset if the granularity of the beam switching among the set of transmit beams is symbol;
causing quasi co-location information of the resources in the first resource set to be associated with a synchronization signal and physical broadcast channel block, SSB, index of a first transmit beam supported by the network device in downlink transmission, the first transmit beam and a receive beam supported by the repeater device in downlink transmission forming a fix beam pair between the network device and the repeater device; or
causing quasi co-location information of the resources in the first resource set to be associated with a set of SSB indexes other than the SSB index of the first transmit beam.

8. The method of claim 3, wherein generating the configuration comprises:
determining the second resource set by causing the number of resources in the second resource set to be the number of transmit beams supported by the network device in downlink transmission or the number of transmit beams supported by the network device minus one.

9. The method of claim 1, further comprising:
receiving results of the first and second measurements from the terminal device; and
determining, based on the results, whether the first link or the second link is to be used for communication between the network device and the terminal device.

10. The method of claim 9, wherein determining whether the first link or the second link is to be used comprises:
determining a selected resource corresponding to a result in the results, the result indicating a link quality higher than a threshold quality;
in accordance with a determination that the selected resource belongs to the first resource set, determining that the first link is to be used for the communication between the network device and the terminal device; and
in accordance with a determination that the selected resource belongs to the second resource set, determining that the second link is to be used for the communication between the network device and the terminal device.

11. The method of claim 9, further comprising:
in accordance with a determination that the first link is to be used, transmitting, to the repeater device, fourth control information indicating turn-on of the repeater device; and
in accordance with a determination that the second link is to be used, transmitting, to the repeater device, fifth control information indicating turn-off of the repeater device.

12. The method of claim 11, wherein the first control information or the fourth control information comprises at least one of the following:
starting time and ending time for the turn-on of the repeater device;
starting time and a duration for the turn-on of the repeater device;
a bit indicating the turn-on of the repeater device; or
a bit indicating maintaining or changing of an on-off state of the repeater device.

13. The method of claim 11, wherein the second control information or the fifth control information comprises at least one of the following:
starting time and ending time for the turn-off of the repeater device;
starting time and a duration for the turn-off of the repeater device;
a bit indicating the turn-off of the repeater device; or
a bit indicating maintaining or changing of an on-off state of the repeater device.

14. A method of communication, comprising:
in response to receiving, from a network device, first control information indicating turn-on of the repeater device, enabling, at a repeater device, a forwarding of a first reference signal transmission between the network device and a terminal device, the first reference signal transmission being forwarded to the terminal device on a resource in a first resource set, the first resource set being configured for a first measurement of a first link between the repeater device and the terminal device; and
in response to receiving, from the network device, second control information indicating turn-off of the repeater device, disabling a forwarding of a second reference signal transmission between the network device and the terminal device, the second reference signal transmission being performed on a resource in a second resource set, the second resource set being configured for a second measurement of a second link between the network device and the terminal device, the first resource set being different from the second resource set.

15. The method of claim 14, further comprising:
receiving, from the network device, third control information regarding beam switching for the repeater device; and
forwarding, based on the third control information, the first reference signal transmission from the network device to the terminal device with different directions.

16. The method of claim 14, further comprising:
transmitting, to the network device, information of a set of transmit beams supported by the repeater device in downlink transmission.

17. The method of claim 16, wherein the information of the set of transmit beams comprises at least one of the following:
the number of transmit beams in the set of transmit beams,
a width of a transmit beam in the set of transmit beams,
a gain of a transmit beam in the set of transmit beams, or
a speed or capability of a beam switching among the set of transmit beams.

18. The method of claim 14, further comprising:
in response to receiving, from the network device, fourth control information indicating turn-on of the repeater device, enabling a forwarding of a first signal transmission between the network device and the terminal device, the first signal transmission being forwarded on the first link; or
in response to receiving, from the network device, fifth control information indicating turn-off of the repeater device, disabling a forwarding of a second signal transmission between the network device and the terminal device, the second signal transmission being performed on the second link.

19. The method of claim 18, wherein the first control information or the fourth control information comprises at least one of the following:
starting time and ending time for the turn-on of the repeater device;
starting time and a duration for the turn-on of the repeater device;
a bit indicating the turn-on of the repeater device; or
a bit indicating maintaining or changing of an on-off state of the repeater device.

20. The method of claim 18, wherein the second control information or the fifth control information comprises at least one of the following:
starting time and ending time for the turn-off of the repeater device;
starting time and a duration for the turn-off of the repeater device;
a bit indicating the turn-off of the repeater device; or
a bit indicating maintaining or changing of an on-off state of the repeater device.

21. A method of communication, comprising:
receiving, at a terminal device and from a network device, a configuration regarding a first resource set and a second resource set, the first resource set being configured for a first measurement of a first link between a repeater device and the terminal device, the second resource set being configured for a second measurement of a second link between the network device and the terminal device, the first resource set being different from the second resource set;
performing the first and second measurements based on the configuration; and
transmitting results of the first and second measurements to the network device.

22. The method of claim 21, wherein the terminal device is unrequired to perform the first and second measurements for more than a predetermined number of resources, the predetermined number being larger than 64.

23. The method of claim 21, wherein the configuration comprises a first period for the first resource set and a second period for the second resource set, the first period being shorter than the second period.

24. The method of claim 21, wherein the number of resources in the first resource set is equal to the number of transmit beams in a set of transmit beams supported by the repeater device in downlink transmission;
wherein a resource in the first resource set is associated with a transmit beam in the set of transmit beams;
wherein resources in the first resource set have the same periodicity;
wherein the resources in the first resource set have different offsets;
wherein the resources in the first resource set to have the same offset;
wherein quasi co-location information of the resources in the first resource set is associated with a synchronization signal and physical broadcast channel block, SSB, index of a first transmit beam supported by the network device, the first transmit beam and a receive beam supported by the repeater device in downlink transmission forming a fix beam pair between the network device and the repeater device; or
wherein quasi co-location information of the resources in the first resource set is associated with a set of SSB indexes other than the SSB index of the first transmit beam.

25. The method of claim 21, wherein the number of resources in the second resource set is equal to the number of transmit beams supported by the network device in downlink transmission or the number of transmit beams supported by the network device minus one.

26. The method of claim 21, wherein the configuration comprises a parameter indicating whether a reference signal is transmitted with the same downlink spatial domain transmission filter, and whether the method further comprises:
receiving the reference signal in a link based on the parameter regardless of the presence or absence of the repeater device in the link.

27. A network device comprising:
a processor configured to cause the network device to perform the method according to any of claims 1 to 13.

28. A repeater device comprising:
a processor configured to cause the repeater device to perform the method according to any of claims 14 to 20.

29. A terminal device comprising:
a processor configured to cause the terminal device to perform the method according to any of claims 21 to 26.
